(19) United States
(12) Patent Application Publication
(10) Pub. No.: US 2006/0266258 A1
(43) Pub. Date: Nov. 30, 2006

(54) Surface-finishing agent and finished material and method of surface finishing

(76) Inventors: Koichi Asakura, Yokohama-shi, Kanagawa (JP); Akihiro Kuroda, Kanagawa (JP); Hikari Takeshige, Kanagawa (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/572,492

(22) PCT Filed: Sep. 16, 2004
(86) PCT No.: PCT/JP04/14001

§ 371 Date: Jul. 18, 2006

(30) Foreign Application Priority Data
Sep. 17, 2003 (JP) 2003-324574
Feb. 27, 2004 (JP) 2004-53791

(51) Int. Cl. C09D 5/20

(52) U.S. Cl. 106/2

(57) ABSTRACT

The present invention provides a surface-treating agent to form fine roughness on the surface of a material and more specifically a surface treating-agent which forms fine roughness on the surface of a material and is easy to process, thereby being useful for materials for highly water-repellent glass, lenses and fabric, materials with an excellent anti-soiling property, panels having an excellent light scattering property, illumination of optical fiber and the like, materials and coatings to prevent accumulation and adhesion of snow or icicle formation on antennas, wires and steel towers, and roughness formation on the surface of semiconductor substrates; the treated materials; and a method of surface treatment to develop the roughness. The surface-treating agent of the present invention has an average primary particle diameter in the range of 1-50 nm, contains fine particles in the range of 5-60% by mass of the total amount of the surface-treating agent in a slurry of nanoparticles which are treated for water repellency and mechanically dispersed in a solvent containing a volatile solvent, and forms a roughness structure with upward protrusions having a spatial periodicity of 0.1-50 μm on the surface of a material by volatilizing the solvent or dipping repeatedly in water upon treating the surface of the material.

### FIELD OF THE INVENTION

The present invention relates to a surface-treating agent to form fine roughness on the surface of a material and the material treated with this surface-treating agent.

Further, the present invention relates to a method of surface treatment to develop fine roughness on a surface of a material.

More specifically, the invention relates to a surface treating-agent which forms fine roughness on a surface of a material and is easy to process, thereby being useful for materials for highly water-repellent glass, lenses and fabric; materials with an excellent anti-soiling property; panels having an excellent light scattering property; illumination of optical fiber and the like; materials and coatings to prevent accumulation and adhesion of snow or icicle formation on antennas, wires and steel towers; roughness formation on the surface of semiconductor substrates; materials for rough surface substrates in which a photocatalyst is used together to improve catalytic effect; and for improving the relative surface area of an exhaust gas treating catalyst.

### BACKGROUND OF THE ART

Until today, various attempts have been made to form fine roughness on a surface of various materials. For example, a method of forming roughness by eluting a component from a coating film (Japanese Patent Laid-Open No. 2001-17907), a coating film which has fine pores with an average pore diameter of less than 200 nm and a method of producing the same (Japanese Patent Laid-Open No. 2001-152138), a porous film structure with a pore diameter of 100 nm to 2 μm and a method of producing the same (Japanese Patent Laid-Open No. 2001-207123), a method using excitation particle beam (http;//www.jvia.gr.jp/j/shinkusangyo/shiryou/thinfilmworld/film23.pdf), and a method using plating, fractal (T. Onda, S. Shinbuichi, N. Satoh, K. Tsujii, Langmuir, 12, 2125-2127 (1996)) have been reported.

### DISCLOSURE OF THE INVENTION

In the abovementioned known methods, although a roughness structure can be formed on a surface of a material, there is a fundamental problem, namely, that the periodic structure is difficult to control, in addition to the disadvantage that the process is complicated and special devices are necessary for different materials. In particular, the method in Japanese Patent Laid-Open No. 2001-152138 has an industrial disadvantage that it takes a long time to form the coating film although the coating has excellent characteristics such as exhibiting water slipping property and forming fine roughness. Further, the method in Japanese Patent Laid-Open No. 2001-207123 has a disadvantage that the resulting coating film has a structure with downward protrusions, which makes the coating film porous and its water-repellency weaker than a coating film structure with upward protrusions.

In view of these problems, the present inventors responded with a completely new unconventional way of thinking. Specifically, the present inventors utilized a concept of an academic field related to the self-organization in the nonequilibrium system, namely, “Dissipative Structures” to which the Nobel Prize in chemistry was awarded in 1977, and found that a fine roughness structure can be spontaneously formed on a surface of a material simply by coating a material with a surface-treating agent which is designed to form a roughness structure at room temperature under normal pressure. Consequently, the present inventors found that the roughness structure has high water slipping property when it is water-repellent and is utilizable for materials such as glass, lenses and fabric; materials with an excellent anti-soiling property; materials and coatings to prevent accumulation and adhesion of snow or icicle formation on antennas, wires and steel towers; roughness formation on the surface of semiconductor substrates; materials for rough surface substrates in which an photocatalyst is used together to improve catalytic effect; and for improving the relative surface area of an exhaust gas treating catalyst. Further, the present inventors found that the fine roughness in which the spatial periodicity is controlled has a function to generate diffused reflection of light uniformly, thereby enabling efficient light-scattering illumination simply by applying on illumination panels or optical fiber. Further, by using a UV shading material such as titanium oxide and zinc oxide as fine particles, a UV shading effect can be imparted to glass and the like.

The invention described in the present application comprises the first to the seventeenth inventions as follows (hereinafter referred to as “the present invention” unless otherwise stated). Namely, the first invention is a surface-treating agent characterized in that the average primary particle diameter is in the range of 1-50 nm, that it contains fine particles in the range of 5-60% by mass of the total amount of the surface-treating agent in a slurry of nanoparticles which are treated for water repellency and mechanically dispersed in a solvent containing a volatile solvent, and that it forms a roughness structure with upward protrusions having a spatial periodicity of 0.1-50 μm on a surface of a material by volatilizing the solvent or dipping repeatedly in water upon treating the surface of the material.

The second invention is a surface-treating agent characterized in that the average primary particle diameter is in the range of 1-50 nm, that it contains fine particles in the range of 5-60% by mass of the total amount of the surface-treating agent in a slurry of nanoparticles which are treated for water repellency and mechanically dispersed in a solvent containing a volatile solvent and further a water-repellent resin component in the range of 0.1-5% by mass of the total amount of the surface-treating agent, and that it forms a roughness structure with upward protrusions having a spatial periodicity of 0.1-50 μm on a surface of a material by volatilizing the solvent or dipping repeatedly in water upon treating the surface of the material.

The third invention is the surface-treating agent further comprising polymeric resins including monomers and oligomers in addition to the nanoparticle slurry treated for water repellency.

The fourth invention is the abovementioned surface-treating agent characterized in that the treatment for water repellency is selected from alkyl silane treatment, alkyl titanate treatment, and alkyl aluminate treatment.

The fifth invention is a material which is obtained by further sintering a material coated with the abovementioned surface-treating agent and has a roughness structure with upward protrusions having a spatial periodicity of 0.1-50 μm on the surface.

The sixth invention is a highly water-repellent material which is obtained by further sintering a material coated with the abovementioned surface-treating agent and further treating for water repellency and has a roughness structure with upward protrusions having a spatial periodicity of 0.1-50 μm on the surface.

The seventh invention is the abovementioned surface-treating agent characterized in that the admixing amount of a liquid component having a dynamic viscosity of greater than 1×10⁻³ m²/s at the temperature used for the surface treatment is less than 10% by mass of the mass of the surface-treating agent.

The eighth invention is the abovementioned surface-treating agent characterized in that the admixing amount of a liquid component having a dynamic viscosity of greater than 1×10⁻³ m²/s at the temperature used for the surface treatment is less than 3% by mass of the mass of surface-treating agent.

The ninth invention is the abovementioned surface-treating agent characterized in that the treatment for water repellency is octylsilane treatment.

The 10th invention is the abovementioned surface-treating agent characterized in that the nanoparticles are one or more selected from titanium oxide, lower titanium oxide, zinc oxide, zirconium oxide, aluminum oxide, carbon black, silicic acid anhydride, cerium oxide, gold, silver, platinum, palladium, rodium, lanthanum, vanadium, tungsten, iron oxide, iron hydroxide and cobalt oxide.

The 11th invention is a surface-treating agent characterized in that it forms a roughness surface exhibiting an efficient photocatalytic effect by admixing a photocatalyst at a concentration not to interfere with roughness formation, namely in less than 5% of the mass of the surface-treating agent.

The 12th invention is the abovementioned surface-treating agent characterized in that a wet medium type pulverizer is used as a method of mechanically dispersing nanoparticles treated for water repellency.

The 13th invention is the abovementioned surface-treating agent characterized in that it further comprises one or more volatile solvents having a boiling point in the range of 40-99° C. at one atm.

The 14th invention is the abovementioned surface-treating agent characterized in that the boiling point of a volatile solvent used upon preparing a slurry of nanoparticles treated for water repellency is in the range of 100-260° C. at one atm.

The 15th invention is the abovementioned surface-treating agent characterized in that the volatile solvent used upon preparing a slurry of nanoparticles treated for water repellency is one or more selected from decamethylcyclopentasiloxane, methyl trimethicone, and tetrakistrimethylsiloxy silane.

The 16th invention is the abovementioned material characterized in that it is a raw material selected from glass, silicon wafer, fiber, synthetic resins, optical fiber, and gas exhaust treating catalysts, or a structure comprising said raw material.

The 17th invention is a method of surface treatment characterized in that a material coated with the abovementioned surface-treating agent is dried and then father soaked in water, thereby further developing roughness on the surface.

### BRIEF DESCRIPTION OF THE DRAWINGS

FIG. 1 shows an example of a scanning electron microscopic photograph of Example 1.

FIG. 2 shows the result of measurements for optical characteristics when a glass plate was treated with the surface-treating agent of Example 1, using a multi-angle spectrophotometer by Murakami Color Research Laboratory Co. Ltd. (Goniophotometer, type GSP-2; incident angle: 45 degrees; receiving angle: −80 to 80 degrees).

FIG. 3 shows the result of measurements for optical characteristics when a glass plate was treated with the surface-treating agent of Comparative Example 1, using the multi-angle spectrophotometer in the same manner as in Example 1.

FIG. 4 shows the result of measurements for optical characteristics when a glass plate was treated with the surface-treating agent of Comparative Example 2, using the multi-angle spectrophotometer in the same manner as in Example 1.

FIG. 5 shows an example of a scanning electron microscopic photograph of Example 4.

FIG. 6 shows an example of a scanning electron microscopic photograph when an aluminum plate was coated with the surface-treating agent of Example 5 and sintered at 300° C.

FIG. 7 shows an example of scanning electron microscopic photograph when a glass plate was coated with the surface-treating agent of Example 5 and sintered at 300° C.

FIG. 8 shows an example of scanning electron microscopic images when a glass plate was coated with the surface-treating agent of Example 5 and sintered at 500° C.

### BEST MODE TO CARRY OUT THE INVENTION

The present invention will be explained in detail as follows.

First, the principle of the roughness structure formation of the present invention is explained.

The surface-treating agent of the present invention has an average primary particle diameter in the range of 1-50 nm, and contains fine particles in the range of 5-60% by mass of the total amount of the surface-treating agent in a slurry of nanoparticles which are treated for water repellency and mechanically dispersed in a solvent containing a volatile solvent, and occasionally it contains a water-repellant resin component in the range of 0.1-5% by mass of the total amount of the surface-treating agent.

In order to simplify the explanation of the invention, a system is chosen as an example, in which 20% ethanol is admixed to a slurry of nanoparticles treated for water repellency containing fine particles dispersed in a volatile cyclic silicone in an amount of about 20% by mass.

The formulation thus prepared has an appearance of a liquid slurry. When this slurry is thinly coated, for example, on a glass plate, ethanol quickly starts to volatilize at room temperature of about 30° C. Ethanol volatilizes faster from the surface of the coating film than from the inside of the coating film and thus the concentrations of the fine particles and the cyclic silicone on the surface of the coating film become higher than those in the inside of the coating film.

However, fluidity is sustained because the cyclic silicone remains. In this state, shrinkage force acts on the surface of the coating film and the shrinkage force is generated unevenly due to fluctuation in concentration under this circumstance. However, diffusion of substances which set off such fluctuation in concentration also takes place at the same time.

Here, according to the theory of Dissipative Structures (see Kondepudi, D. K. and Prigogine, I. (1988), Modern Thermodynamics—From Heat Engines to Dissipative Structures, John Wiley & Sons, New York, Chap. 19: Dissipative Structures, pp. 427-457), the time required to suppress the fluctuation due to diffusion competes with the time required for shrinkage and thus a structure of spatial fluctuation of critical wavelength develops, thereby forming a structure having a spatial periodicity with certain intervals.

For example, in the abovementioned state, a roughness structure having a spatial periodicity of one to several μm can be formed using mechanically dispersed fine particles of octyl silylated titanium oxide as nanoparticles treated for water repellency. On the contrary, when large fine particles such as pigment grade titanium oxide particles with a size of 200 nm are used alone, shrinkage force cannot affect efficiently because the size of the fine particles is too large so that there is no competition of force to form the structure. Further, when a water-repellent resin component is admixed in a large amount, the material diffusion is weakened and loses its competition of force, thereby no fluctuation being developed to form the structure; however, when the resin component is used in the range given in the present invention, fluidity of the coating film remains thus the structure can be formed. When the abovementioned nonvolatile component consists of fine particles alone, the resulting structure is physically complete but the coating film is disadvantageously decomposed by a surfactant or the like; however, when the water-repellent resin component is admixed, the resulting coating film is a firm structure comprising the fine particles and resin and characterized by its excellent durability. Accordingly, electron microscopic observation of the top of the roughness part obtained in the present invention shows the fine particles not singly but as linear structures.

The coating film formation by utilizing such a force competition of force of the theory of Dissipative Structures has not conventionally existed; the structure cannot be formed even if similar components are contained unless the force balance is intentionally changed.

Accordingly, in the present invention, it is necessary to be able to form a roughness structure with upward protrusions having a spatial periodicity of 0.1-50 μm by admixing a specific component in a certain ratio as mentioned above and further volatilizing a solvent or repeatedly dipping in water. The surface structure with upward protrusions means the state that the roughness with upward protrusions is formed after the roughness formation whereas the interface is smooth immediately after coating with a surface-treating agent; the expression “with downward protrusions” means the state that there are open holes on the smooth interface immediately after coating with a surface-treating agent. It is obvious from electron microscopic observation that the coating film treated with the surface-treating agent has upward protrusions. Generally, ordinary surface-treating agents contain a highly viscous oily agent as an ingredient, or have extremely high or low volatility and thus are designed to provide a smooth surface coating film; these known technologies are different from those of the present invention.

The nanoparticles treated for water repellency to be used in the present invention have an average primary particle diameter in the range of 1-50 nm; this average primary particle diameter is obtained by observation of particle size distribution using an electron microscope.

Further, when secondary agglomerates present in the surface-treating agent have an average particle diameter of greater than 200 nm and the number of the secondary particles exceeds 30% of that of the entire particles, no coating film having substantial periodicity is formed even when the primary particle diameter is within the abovementioned range, which is considered to be beyond the scope of the present invention.

In the present invention, one or more kinds of nanoparticles treated for water repellency exhibiting this range of particle distribution are combined. An example of the treatment for water repellency to be used in the present invention is preferably a treatment not to disperse in a 10% by mass ethanol aqueous solution, such as alkyl silane treatment, alkyl titanate treatment, alkyl aluminate treatment, silicone (methylhydrogen polysiloxane) treatment, pendant treatment (addition of an olefin compound after methylhydrogen polysiloxane treatment), metal soap treatment, end-reactive silicone treatment, end-reactive perfluoropolyether treatment, fluoroalkylsilane treatment, treatment with perfluoroalkyl phosphate and salts thereof, and treatment with a silane coupling agent.

In the present invention, they may be used alone or in combination of more thanone. Among them, alkyl silane treatment, alkyl titanate treatment, and alkyl aluminate treatment, which can particularly improve dispersion of the fine particles, are preferable and octylsilylation treatment is particularly preferable. Further, as to fine particles treated with a fluorine compound, when the amount to be mixed is increased, phase separation occurs in the process of drying a preparation, which makes it difficult to control the coating, and the fine particles treated with a fluorine compound are often water repellent and oil repellent and thus poorly immobilized onto a surface of a treated material, which may result in elimination and agglomeration of the fine particles in contact with water or snow; accordingly, when admixed to a preparation, the amount is preferably controlled in the range of 0.001-30% by mass of the total amount of the nanoparticles treated for water repellency. Further, as also shown in a comparative example of the present invention, fine particles treated with a fluorine compound show a high contact angle when a water droplet is dropped gently on the coating film, whereas in moving water, the entire coating film gets wet and water repellency is occasionally lost.

The fine particles used in the present invention are one or more selected preferably from titanium oxide, lower titanium oxide, zinc oxide, zirconium oxide, aluminum oxide, carbon black, silicic acid anhydride, cerium oxide, gold, silver, platinum, palladium, rodium, lanthanum, vanadium, tungsten, iron, iron oxide, iron hydroxide, cobalt oxide, cobalt hydroxide, zinc phosphate, barium sulfate, magnesium aluminosilicate, calcium aluminosilicate, hydroxyapatite, tin oxide, silicon carbonate, silicon nitride, titanium nitride, indium oxide/tin oxide complex, and complex compounds thereof; in particular, the nanoparticles are one or more preferably selected from titanium oxide, lower titanium oxide, zinc oxide, zirconium oxide, aluminum oxide, carbon black, silicic acid anhydride, cerium oxide, gold, silver, platinum, iron oxide, iron hydroxide, and cobalt oxide. Further, the kind of fine particles is preferably changed depending on the purpose of surface treatment. For example, when the treatment is for protection from ultraviolet rays, titanium oxide, zinc oxide, and cerium oxide are preferably used; when the treatment is for light scattering, titanium oxide having a high refractive index is preferably admixed; for the purpose of securing transparency, silicic acid anhydride is preferably used.

The shape of the fine particles used in the present invention can be various including rod, spindle, round, and amorphous shapes. Further, it is also preferable to perform surface pretreatment with a compound such as silica, alumina and zinc phosphate for the purpose of suppressing catalytic activity of the fine particles.

Examples of the method of treating for water repellency used in the present invention include a wet mixing method using a solvent, a gas phase method such as CVD, and a dry mixing method; however, the wet mixing method is most preferable because it secures the uniformity of the treatment. In particular, it is preferable to perform surface treatment while carrying out pulverization using a wet medium type mill such as a bead mill and a sand mill. Further, it is preferable to add heat treatment for the purpose of completing the treatment.

A slurry used in the present invention contains nanoparticles treated for water repellency which have an average primary particle diameter in the range of 1-50 nm and are mechanically dispersed in a solvent containing a volatile solvent. Examples of the method of mechanically dispersing the nanoparticles treated for water repellency include a method of pulverization using a wet medium type pulverizer, a method using a roll mill and a method in which a slurry is ejected under high pressure; however, the method using a wet medium type pulverizer, which is easy to manage and excellent for mass production, is most preferred.

Examples of the volatile solvent used in the present invention include preferably one or more selected from decamethylcyclopentasiloxane, methyl trimethicone, tetrakistrimethyl siloxy silane, volatile linear silicones, alkyl modified silicones, fluorocarbon, toluene, hexane, cyclohexane, petroleum ether and light isoparaffin. In particular, it is preferred to use a volatile solvent having a boiling point in the range of 100-260° C. at one atm, which is highly safe for work. This range is advantageous to provide highly safe working conditions for mechanical pulverization. Such examples include decamethylcyclopentasiloxane (boiling point: 210° C.), methyl trimethicone (boiling point: 190° C.) and tetrakistrimethyl siloxy silane (boiling point: 222° C.).

In the present invention, a nonvolatile solvent can be used together with these volatile solvents; however, the final content of a nonvolatile oily solvent has to be not more than 20% by mass of the surface-treating agent. When the amount of the nonvolatile oily agent exceeds 20% by mass, shrinkage force on the coating surface becomes weak and the structure formation is difficult and moreover the strength of the resulting structure is disadvantageously decreased. Further, the content of the nanoparticles treated for water repellency in the slurry used in the present invention is preferably in the range of 5-55% by mass, more preferably 25-50% by mass, of the total amount of the slurry. When it is less than 5% by mass, the amount of the fine particles is too small to control the coating film structure, while when it exceeds 55% by mass, secondary agglomerates of the fine particles cannot sufficiently be disintegrated into primary particles and a large amount of agglomerated particles are mixed, which makes it disadvantageously difficult to form a roughness structure of the coating film. The fine particles in a slurry of nanoparticles treated for water repellency used in the present invention are preferably dispersed as uniformly as possible. When they are uniformly dispersed, a uniform roughness structure can be formed.

Further, in the present invention, it is possible to admix nanoparticles without treatment for water repellency and pigments together with nanoparticles treated for water repellency; however, the content of admixing has to be minimized because they interfere with the structure formation. More specifically, the content is preferably not more than 20% by mass of the nanoparticles treated for water repellency.

In the present invention, the average primary particle diameter is in the range of 1-50 nm and the fine particle content is in the range of 1-60% by mass of the total amount of the surface-treating agent, in a slurry of nanoparticles which are treated for water repellency and mechanically dispersed in a solvent containing a volatile solvent. A roughness structure can be stably formed in this range. When the content is less than 1% by mass, the structure cannot be formed; when the content exceeds 60% by mass, the concentration of the fine particles is too high and agglomeration of the fine particles or the like occurs, which occasionally results in an uneven roughness structure of the coating film.

In the present invention, one or more volatile solvents having a boiling point in the range of 40-99° C. at one atm are preferably contained at the same time. Examples of the volatile solvents having a boiling point of this range include lower alcohols such as ethyl alcohol (boiling point: 78° C.), propyl alcohol (boiling point: 97° C.) and isopropyl alcohol (boiling point: 83° C.); ethyl alcohol and isopropyl alcohol are particularly preferable.

In the present invention, the content of this volatile solvent is in the range of 2-60% by mass of the total amount of the surface-treating agent. In this range, advantageously, the shrinkage force of the coating film effectively functions.

Further, when the content is less than 2% by mass, there arises a problem that the shrinkage force of the coating film is weak so that the structure is difficult to form; when the content exceeds 60% by mass, volatility becomes high so that there arises problems that uniform coating film with the surface-treating agent is difficult to form and that the solvent concentration in the working environment increases, although the solvent is effective for sterilization of the coating film.

These conditions are based on the consideration that the work is carried out in an open system at atmospheric pressure; when specific solvent recovering apparatus or coating apparatus is used, it is possible to use a more highly concentrated or non-mixed solution.

The surface-treating agent of the present invention is characterized in that when used for treating a surface of a material, it forms a roughness structure with upward protrusions having a spatial periodicity of 0.1-50 μm on the surface by volatilizing a solvent or repeatedly dipping in water. Examples of the method for surface treatment are simple and include a method of immersing a material in the surface-treating agent, a method of coating with the surface-treating agent using a brush, a method of coating with the surface-treating agent using a spray and a method by printing; however, the method by printing is preferable.

The thickness of the coating film upon coating with the surface-treating agent of the present invention is in the range of 0.5-100 μm; the range of 1-10 μm is more preferable to be able to obtain an orderly roughness structure. In this range, the roughness structure of the coating film can advantageously be formed more firmly.

Further, the reaction is carried out at a temperature in the range of preferably 20-60° C., more preferably 35-45° C. In this range, the volatilizing speed of the volatile solvent is appropriate to form the roughness structure.

In the present invention, it is possible to further develop the roughness structure by repeatedly dipping a material in water at the stage where the coating film gets dry after treating the material with the surface-treating agent. This is because shrinkage force greater than the surface shrinkage force generated upon volatilizing the volatile solvent is obtained due to hydrophobicity of the fine particles, the solvent and the resins. The roughness structure is preferably confirmed by a noncontact type surface micro roughness meter or an electron microscope.

Further, the spatial periodicity can be confirmed, for example, by a method in which a photograph obtained using an electron microscope is processed into data using an image scanner and the spatial periodicity is confirmed from a power spectrum by using an image analysis software (for example, a spatial periodicity analysis software distributed by USA National Institute of Health (NIH) http://www.nih.gov/). The roughness of the coating film obtained by the theory of Dissipative Structures used in the present invention has a spatial periodicity of 0.1-50 μm. When the spatial periodicity is less than 0.1 μm, characteristics such as water repellency is not desirable while when the spatial periodicity exceeds 50 μm, the roughness of the coating film is not perfectly controlled and thus the coating film cannot uniformly formed.

In the present invention, it is preferable that the periodic structure of the coating film is uniformly formed in the entire coating film; however, when more than 50% of the coated area show the roughness structure, it is considered to satisfy the present invention since ununiformity is occasionally generated due to various conditions (for example, coating conditions, the amount of coating). In the case of less than 50%, various characteristics (water repellency, optical properties, snow resistance, and the like) attributed to the roughness structure become disadvantageously deteriorated. The amount of coating of the surface-treating agent of the present invention depends on the characteristics of a material; however, the amount of approximately 0.01-2 mg/cm² is preferably coated on the surface of the material. When the amount is less than 0.01 mg/cm², a uniform coating film is difficult to be formed. When the amount exceeds 2 mg/cm², the roughness formation may be insufficient in some areas.

It is best confirmed by electron microscopic observation whether the surface-treating agent of the present invention is a preparation which can form the roughness structure based on the theory of Dissipative Structures; however, a periodic structure may be considered to be formed when the contact angle measured after treatment with water is more than 10 degrees higher than that measured before treatment with water, in which, for example, a glass plate treated with the surface-treating agent on the surface in an amount of coating of 0.25 g/cm² is dried at 37° C. for 10 minutes under air flow and repeatedly placed in and out of running water (4 L/min) at 35° C. for one minute at a rate of 100 times/min slanting at an angle of 30 degrees from the horizontal. Contrarily, the contact angle remains the same or decreases after treatment with water when the periodic structure is not formed. However, since this measuring method is a simplified one, there are cases where the measurement shows no increase in the contact angle while the structure is observed by electron microscopic observation, although very rarely.

Examples of the water-repellent resin component used in the present invention include one having a property to be dissolved in a volatile solvent, further a water-repellent resin component such as silicone resins, and one produced by chemically modifying a hydrophilic resin component into water-repellent one such as siliconated pullulane. The water-repellent resin component can be any resin component ordinarily used, including trimethylsiloxy silicate, peroxyfluoroalkylated silicone resins, acrylic silicone, polyamide modified silicones, alkyl modified silicones, polystyrene, nitrocellulose, ethylcellulose, alkyl acrylates, alkyl methacrylates, modified alkyd resins, and carnauba wax. The admixing amount of the water-repellent resin component used in the present invention is, for example, in the range of 0.1-5% by mass of the total amount of the surface-treating agent. In this range, the fine particles can be immobilized onto a material, forming the roughness structure. Disadvantageously, the immobilization of the fine particles becomes weak when the amount is less than 0.1% by mass and the roughness structure is difficult to be formed when the amount exceeds 5% by mass.

In the present invention, the coating film obtained as abovementioned can be immobilized onto a material by sintering altogether with the material. Since the roughness structure according to the present invention is merely a structure comprising fine particles, a resin component, and additives to be mentioned later, it is not durable for long-time use, such as use for auto glass. Here, by sintering the coating film itself, the roughness structure of the coating film can be firmly immobilized onto the surface of the material. In this case, the temperature for sintering is preferably, for example, in the range of 300-800° C. Disadvantageously, carbon remains and coloring occurs when the temperature is too low and the material itself may melt so that the structure of the coating film cannot be maintained when the temperature is too high. However, when treatment is sintering alone, the roughness structure is hydrophilic or poorly water-repellent and lacks characteristics such as water slipping property; accordingly, depending on the usage, the surface of the coating film is further treated for water repellency, for example, by silicone treatment, fluorine compound treatment, or silane treatment to obtain excellent characteristics.

In sintering, together with the surface-treating agent, a nonvolatile silicone oil, one having a dynamic viscosity preferably in the range of 1-30×10⁻⁶ m²/s, is preferably used. In this case, the silicone oil is chemically changed into silica upon sintering to immobilize the fine particles, thereby advantageously improving the strength of the coating film.

Examples of the material used in the present invention include raw materials, such as glass, silicon wafer, fiber, synthetic resins, building materials, optical fiber, resin film, the surface of steel towers or the bottom of ships to be coated, wire, metal plates, semiconductor substrates, ceramics and exhaust gas treating catalysts (e.g., denitrification apparatus, ternary catalysts), and structures comprising said materials; in particular, raw materials such as glass, silicon wafer, fiber, synthetic resins, optical fiber, exhaust gas treating catalysts or structures comprising said materials are preferable.

In the present invention, it is possible to admix various kinds of oil agents, pigments, color materials (coloring agents), additives, UV absorbing agents, antioxidants, surfactants, preservatives and the like in addition to the abovementioned ingredients; however, the admixing amount of a liquid component having a dynamic viscosity of greater than 1×10⁻³ m²/s at the temperature used for the surface-treating agent is preferably less than 10% by mass, more preferably less than 3% by mass, of the amount of the surface-treating agent. This is because the oily solvent having a dynamic viscosity of greater than 1×10⁻³ m²/s interferes with shrinkage force and diffusion associated with volatilization of the volatile solvent and affects in the direction to suppress the development of fluctuation, which makes the periodic structure formation difficult. Here, the standard of this dynamic viscosity is a dynamic viscosity at the time of use of the surface-treating agent; accordingly for components such as reactive monomers whose viscosity is low upon processing but increases with time, a dynamic viscosity at the original monomer state is to be applied. Further, when the dynamic viscosity cannot practically be measured due to factors such as a high surface treatment temperature and volatilization, the measurement can be carried out under controllable conditions such as at room temperature.

In the present invention, the total amount of these additive components, excluding water-soluble components such as water and polyvalent alcohols, is preferably less than 30% by mass, more preferably less than 20% by mass, of the total amount of the surface-treating agent. In this form of preparation, the water-soluble components are known to have little effect on the structure formation of the coating film but other components, particularly oil-soluble components, often affect the structure formation and the spatial periodicity. Further, pigments/color materials (in this case, those having a primary particle diameter of 50 nm to 1 mm) can be admixed; however it is preferable that the total admixing amount is limited to in the range of 0.0001-20% by mass of the total amount of the surface-treating agent and that the surface is treated for water repellency in the same manner as for the abovementioned nanoparticles. Further, the abovementioned nanoparticles are preferably admixed in an amount equal to or greater than the mass of the pigments/color materials.

These pigments/color materials do not form the structure because of the abovementioned reasons but can form the structure in combination with the abovementioned nanoparticles. However, in case the abovementioned nanoparticles are combined, the amount of admixing is preferably limited within the abovementioned range because when the amount of the pigments/color materials is too much, substance diffusion is interfered with and thus the structure cannot be formed. Further, among the pigments, in particular, particles exhibiting photocatalytic activity, i.e., anatase-type titanium oxide, precious metal-containing titanium oxide, and pigment-containing titanium oxide, with an average primary particle diameter in the range of 5 nm to 0.3 um can be used to obtain a function as an anti-soiling material.

In admixing, the amount of these photocatalysts is preferably less than 10%, more preferably less than 5%, of the mass of the surface-treating agent of the present invention. However, since the roughness formation is occasionally interfered with depending on the dispersive state of the photocatalytic particles, it is important to admix the photocatalysts in a concentration not to interfere with the roughness formation, for example, simultaneously using mechanical dispersion, to form a roughness surface having photocatalytic effects. A photocatalyst-contacting area can be advantageously increased by the roughness formation.

In the present invention, monomer reactive raw materials are also preferably used together with the abovementioned components. Examples of monomer reactive raw materials include various known compounds including heat reactive compounds, photoreactive compounds (ultraviolet light-reactive compounds, ultra red light-reactive compounds), electron beam- or plasma-reactive compounds, compounds which react with catalyst, radical reactive compounds, and compounds which form cross-linked compounds by reacting with metal ions, such as unsaturated fatty acids.

Examples of polymeric resin compounds including these monomers and oligomers include those containing one or more compounds selected, for example, from epoxy compounds, acrylamide monomers (e.g., acrylamide, N-isopropylacrylamide), acrylic monomers (e.g., acrylic acid, methacrylic acid, isobutyl acrylate), acrylic oligomers, drying oil (e.g., linseed oil, poppy oil), polyvinyl cinnamate compounds, unsaturated polyester compounds, dichromic acid compounds, ene-thiol compounds, modified silicone compounds, silane compounds such as vinylsilane and silane coupling agents, allyl diglycol carbonates, multifunctional cyclic carbonate compounds, multifunctional (metha) acrylates (e.g., urethane (metha) acrylate, epoxy (metha) acrylate), cyanoacrylate, phthalic acid compounds and acrylsilicone compounds; however, since compounds having a boiling point of lower than 100° C. at one atm volatilize by themselves and are difficult to control, their boiling points at one atm are preferably changed to higher than 100° C. by oligomerization or the like.

Further, as to reaction assisting components or reaction initiating agents such as photoreaction initiating agents and radical reaction initiating agents or ion supplementing agents, the abovementioned limitations are not applied. However, when these monomer reactive raw materials are used in environments such as outdoors, at room temperature or at an atmospheric temperature, the admixing amount of the liquid component having a dynamic viscosity at 25° C. of more than 1×10⁻³ m²/s is preferably less than 10% by mass, more preferably less than 3% by mass, of the mass of the surface-treating agent. However, when the treatment is carried out at a higher temperature or under reduced pressure in a closed atmosphere, the amount of admixing is not limited as long as the dynamic viscosity at the temperature used is less than 1×10⁻³ m²/s.

The formulation of the present invention can be an emulsion type, a solvent type, or a multilayer separation type; however, the multilayer separation type which is shaken or stirred upon use is preferable.

An example of a method of designing the surface-treating agent of the present invention is shown as follows.

First, the kind of nanoparticles is determined to meet the purpose of use. For example, when UV light is involved, a material such as titanium oxide, zinc oxide, tungsten oxide, and cerium oxide can be used; when light scattering is involved, zinc oxide, silica dioxide, zirconium oxide, and the like are preferable; when catalysis is involved, cerium oxide, platinum, rodium, palladium, and the like are preferable; when water repellency is of interest, titanium oxide, cerium oxide, silica dioxide, zirconium oxide, and the like are preferable; and as an anti-soiling material, titanium oxide having a photocatalytic activity is preferable. Next, these nanoparticles are treated for water repellency, in which it is necessary to disintegrate agglomerates and to prevent reagglomeration since the nanoparticles are strongly agglomeratable.

An example of an excellent surface treatment which is effective in preventing reagglomeration is a treatment with octyltriethoxy silane, in which the nanoparticles and octyltriethoxy silane are simultaneously wet-pulverized in a solvent and thus cut faces successively react with octyltriethoxy silane, thereby reagglomeration is prevented to obtain a highly dispersive treating powder. This material can be used as it is or made into a slurry by returning it into the solvent. Preparations are prepared by admixing this slurry in concentrations by 10% difference, components to immobilize the coating film such as adhesives, resins, and reactive compounds in various levels of concentrations and a volatile solvent to total 100%. Next, differences in the contact angle after and before treatment with water for the individual sample preparations are obtained to draw a graph, thereby the ranges in which the contact angle increases specifically to these ingredients being obtained. This range generally agrees with the range where the roughness periodic structure is formed based on the theory of Dissipative Structures. After this range is set, other substantially necessary components such as additives and coloring agents are added to these ingredients of this range at various admixing levels and the similar procedure is carried out. In this way, a composition exhibiting a large contact angle difference and in the range agreed with the purpose of use is searched and thus a composition of the surface-treating agent of interest can be obtained.

The following examples and comparative examples will explain the present invention more in detail.

Further, methods for evaluation of various characteristics used in the examples and comparative examples are shown as follows.

(1) Method of Measuring Contact Angle

One side of a glass plate (5 cm×10 cm×3 mm) having a hydrophilic surface was coated with 12 mg of a surface-treating agent and dried at 37° C. for 10 minutes using an air blow dryer. The contact angle was measured from photographic data immediately after contact with a water droplet using a contact angle measurement apparatus (contact angle measurement apparatus (Type CA-DT) by Kyowa Interface Science). Further, the contact angle was measured after placing this glass plate in and out of running water (4 L/min) for one minute at a rate of 100 times/min slanting at an angle of 30 degrees from the horizontal.

(2) Confirmation of Roughness and Measurement of Spatial Periodicity

By using a scanning electron microscope, the roughness formation was confirmed from a photograph measured at a magnitude of 3000 and the spatial periodicity was measured from a power spectrum of the photograph using the abovementioned NIH image software.

### EXAMPLE 1

40 parts by mass of octylsilylated fine particle titanium oxide (silica/alumina-treated fine particle titanium oxide treated with 10% by mass octyltriethoxy silane; average particle diameter: 35 nm; being dried and heated after reacting in a bead mill using toluene as a solvent) and 60 parts by mass of decamethylcyclopentasiloxane (a kind of cyclic volatile silicones; boiling point: 210° C.) were roughly mixed and then finely pulverized using a bead mill (a horizontal sand grinding mill) to obtain a slurry of octylsilylated fine particle titanium oxide in which octysilylated titanium oxide fine particles were uniformly dispersed.

Further, 45 parts by mass of octylsilylated fine particle zinc oxide (fine particle zinc oxide treated with 10% by mass octyltriethoxy silane; average particle diameter: 10 nm; being dried and heated after reacting in a bead mill using toluene as a solvent) and 55 Parts by mass of decamethylcyclopentasiloxane were roughly mixed and then finely pulverized using a bead mill (a horizontal sand grinding mill) to obtain a slurry of octylsilylated fine particle zinc oxide in which octylsilylated zinc oxide fine particles were uniformly dispersed.

Using these materials, a product (a surface-treating agent which exhibits light scattering) was obtained with the ingredients shown in Table 1.

Here the unit in Table 1 is % by mass.

TABLE 1

| | |
|---|---|
| Component A | |
| Octylsilylated fine particle titanium oxide slurry | 1 |
| Octylsilylated fine particle zinc oxide slurry | 40 |
| Methyl trimethicone | 10 |
| Dimethyl polysiloxane (KF96A10cs, Shin-Etsu Chemical | 10 |
| Co., Ltd.) | |
| Trifluoropropylated trimethylsiloxysilicate 50% by mass | 2 |
| decamethylcyclopentasiloxane solution | |
| Decamethylcyclopentasiloxane | 8 |
| Sorbitan monoisostearate | 1 |
| Component B | |
| Ethyl alcohol | 5 |
| Preservative | Appropriate |
| Anti-mold agent | Appropriate |
| Component C | |
| Purified water | Balance |

After homogeneously mixing component A, component B in solution was added and then component C was added, after which the resulting admixture was stirred and then filled into a container to make the product.

The product of Example 1 had a contact angle of 80 degrees and a contact angle after treatment with water of 105 degrees, which showed water repellency.

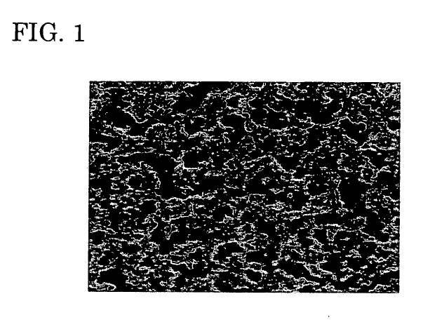

An example of the electron microscopic photograph of the product of Example 1 is shown in FIG. 1.

The result of the analysis of this photograph showed that the spatial periodicity was about 1 μm.

The scanning electron microscopic photograph of FIG. 1 shows a size of 10 μm in length and 13.3 μm in width.

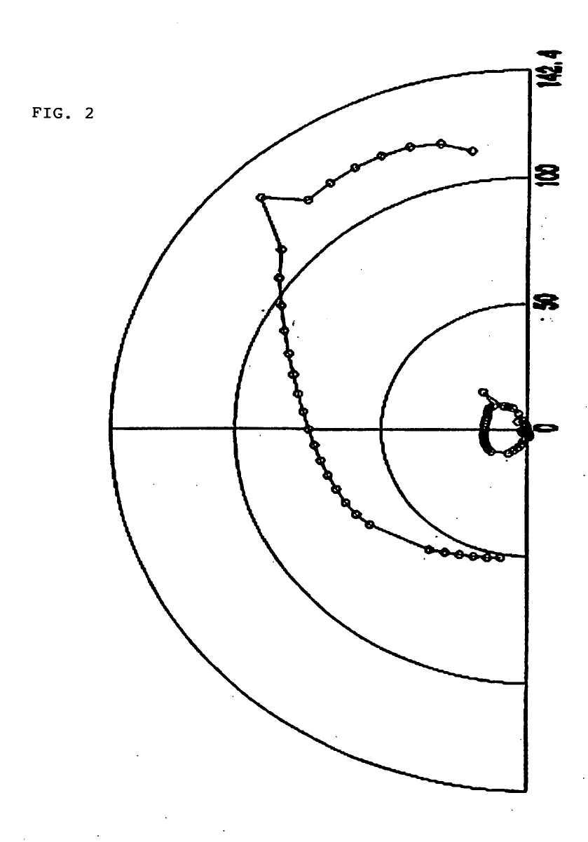

Further, optical characteristics were measured when a glass plate was treated with the surface-treating agent of Example 1, using a multi-angle spectrophotometer (Goniophotometer by Murakami Color Research Laboratory Co., Ltd., Type GSP-2; incident angle: 45 degrees; receiving angle: −80 to 80 degrees). The result is shown in FIG. 2.

Here the sample was coated in an amount of 1 mg/cm² and dried at 37° C. for 15 minutes.

The result in FIG. 1 reveals that the product of Example 1 exhibits a periodic structure. It is also revealed that the product of Example 1 scattered light uniformly and highly efficiently as shown in data in FIG. 2, although it appears transparent.

### EXAMPLE 2

A glass plate was coated with the surface-treating agent of Example 1 in an amount of 0.25 mg/cm² and dried at 37° C. for 60 minutes, after which it was heated at 500° C. for one hour in a sintering oven.

The resulting coating film was hydrophilic but it maintained the coating film roughness structure similar to that mentioned above.

### EXAMPLE 3

The surface-treated glass plate of Example 2 was coated with a 5% by mass isopropyl alcohol solution of perfluoroalkyl phosphate ester and dried at 80° C. for 3 hours.

The coating film thus obtained showed extremely high water repellency.

### COMPARATIVE EXAMPLE 1

50 parts by mass of octylsilylated pigment-grade titanium oxide (pigment-grade titanium oxide treated with 10% by mass octyltriethoxy silane; average particle diameter: 250 nm; being dried and heated after reacting in a bead mill using toluene as a solvent) and 50 parts by mass of decamethylcyclopentasiloxane were roughly mixed and then finely pulverized using a bead mill (a horizontal sand grinding mill) to obtain a slurry of octylsilylated pigment-grade titanium oxide in which octylsilylated pigment-grade titanium oxide particles was uniformly dispersed. 32 parts by mass of the slurry of octylsilylated pigment-grade titanium oxide, 20 parts by mass of ethanol, and 48 parts by mass of decamethylcyclopentasiloxane were mixed and filled into a container to obtain a product.

The product of Comparative Example 1 exhibited a contact angle of 140 degrees and a contact angle after treatment with water of 141 degrees, which showed water repellency.

The result of scanning electron microscopic observation of the product of Comparative Example 1 revealed that the fine particles of the product of Comparative Example 1 were agglomerated and showed no periodic structure.

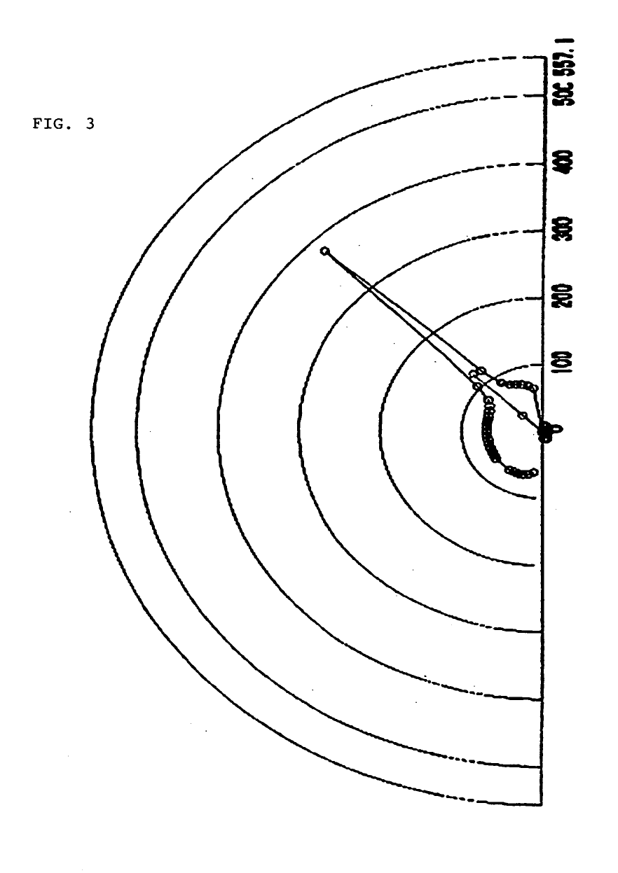

Further, optical characteristics were measured when a glass plate was treated with the surface-treating agent of Comparative Example 1, in the same manner as described in Example 1 using a multi-angle optical photometer. The result is shown in FIG. 3.

Here the sample was coated in an amount of 1 mg/cm² and dried at 37° C. for 15 minutes. FIG. 3 reveals that with the product of Comparative Example 1, reflectivity in the direction of regular reflection was high and thus uniform scattering was not exhibited.

### COMPARATIVE EXAMPLE 2

Using the slurry of octylsilylated fine particle titanium oxide and the slurry of octylsilylated fine particle zinc oxide of Example 1, a surface-treating agent was prepared with the ingredients shown in Table 2.

TABLE 2

| | |
|---|---|
| Octylsilylated fine particle titanium oxide slurry | 2 |
| Octylsilylated fine particle zinc oxide slurry | 46 |
| Methyl trimethicone | 20 |
| Dimethyl polysiloxane (KF96A10cs, Shin-Etsu Chemical Co., Ltd.) | 10 |
| Methyl alcohol | 20 |

The product of Comparative Example 2 exhibited a contact angle of 108 degrees and a contact angle after treatment with water of 108 degrees, which showed water repellency.

The result of scanning electron microscopic observation of the product of Comparative Example 2 revealed that the product of Comparative Example 2 exhibited no periodic structure.

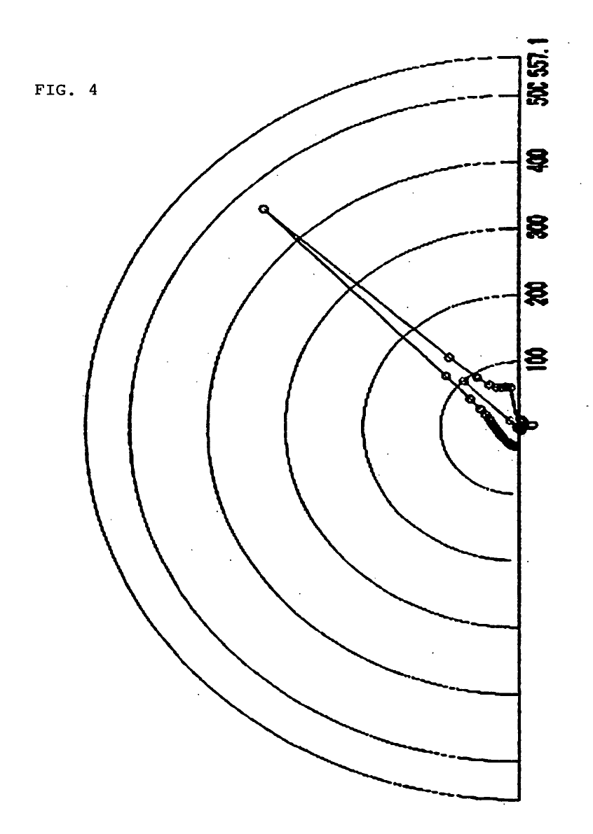

Further, optical properties were measured when a glass plate was treated with the surface-treating agent of Comparative Example 2 in the same manner as described in Example 1 using a multi-angle spectrophotometer. The result is shown in FIG. 4.

Here the sample was coated in an amount of 1 mg/cm² and dried at 37° C. for 15 minutes.

FIG. 4 reveals that with the product of Comparative Example 2, reflectivity in the direction of regular reflection was high and thus uniform scattering was not exhibited.

### COMPARATIVE EXAMPLE 3

16 parts by mass of silica/alumina-treated fine particle titanium oxide treated with 5% by mass perfluoroalkyl phosphate ester diethanolamine salt (average particle diameter: 35 nm), 64 parts by mass of decamethylcyclopentasiloxane, and 20 parts by mass of ethyl alcohol were admixed and pulverized and the resulting solution is filled into a container to make a product (surface-treating agent).

The product of Comparative Example 3 exhibited such a high contact angle as 145 degrees after coating and 140 degrees after treatment with water; however, in running water, the entire coating film immediately became wet and no substantial water repellency was exhibited.

Accordingly, data after treatment with water were obtained by measuring a sample which was dried at 37° C. for 10 minutes after treatment with water. Further, no orderly periodic structure was formed.

### COMPARATIVE EXAMPLE 4

16 parts by mass of silica/alumina-treated fine particle titanium oxide treated with 5% by mass perfluoroalkyl phosphate ester diethanolamine salt (average particle diameter: 35 nm), 60 parts by mass of decamethylcyclopentasiloxane, 20 parts by mass of ethyl alcohol, and 4 parts by mass of a trifluoropropylated trimethylsiloxy silicate solution (a 50% by mass decamethylcyclopentasiloxane solution) were admixed and pulverized and the resulting solution was filled into a container to make a product (surface-treating agent). The product of Comparative Example 4 exhibited such a high contact angle as 149 degrees after coating and 141 degrees after treatment with water; however, in running water, the entire coating film immediately became wet and no substantial water repellency was exhibited. Accordingly, data after treatment with water were obtained by measuring a sample which was dried at 37° C. for 10 minutes after treatment with water, in the same way as in Comparative Example 3. Further, no orderly periodic structure was formed.

From the results above, it is revealed that simple coating of the products of Examples of the present invention forms a fine roughness structure with upward protrusions and provides excellent water repellency and optical characteristics. Contrarily, in Comparative Examples, the fine roughness structure was either not or ununiformly formed and the optical characteristics were also inferior.

The followings are an example in which drying oil (room temperature setting resin) was admixed and an example in which sintering was performed.

### EXAMPLE 4

A mixed solution of 50 parts by mass of the octylsilylated fine particle titanium oxide slurry used in Example 1, 5 parts by mass of linseed oil, and 45 parts by mass of decamethylcyclopentasiloxane was filled into a container to make a product (surface-treating agent).

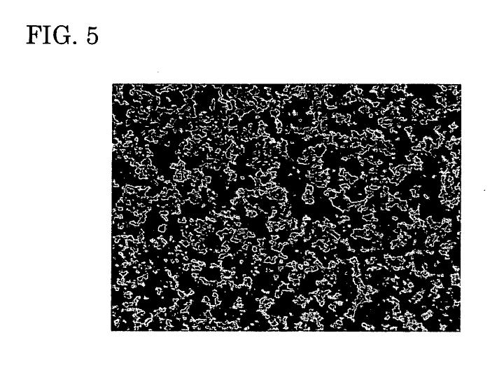

One side of a glass plate (5 cm×10 cm×3 mm) having a hydrophilic surface was coated with 12 mg of the surface-treating agent and dried at 50° C. for 10 minutes using an air blow dryer. When this glass plate was repeatedly placed in and out of running water (4 L/min) at 38° C. for one minute at a rate of 100 times/min slanting at an angle of 30 degrees from the horizontal, the fine periodic structure with upward protrusions was confirmed as shown in FIG. 5.

The width of FIG. 5 is 20 μm.

### EXAMPLE 5

20 parts by mass of octylsilylated fine particle zinc oxide slurry used in Example 1, 20 parts by mass of octylsilylated pigment grade titanium oxide slurry used in Comparative Example 1, 10 parts by mass of octyl para-methoxycinnamate, 43 parts by mass of decamethylcyclopentasiloxane, 5 parts by mass of ethyl alcohol, and 2 parts by mass of a trifluoropropylated trimethylsiloxy silicate solution (a 50% by mass decamethylcyclopentasiloxane solution) were admixed and pulverized and the resulting solution was filled into a container to make a product (surface-treating agent).

The product of Example 5 exhibited a contact angle of 96 degrees after coating and 128 degrees after treatment with water, showing a big difference before and after treatment with water.

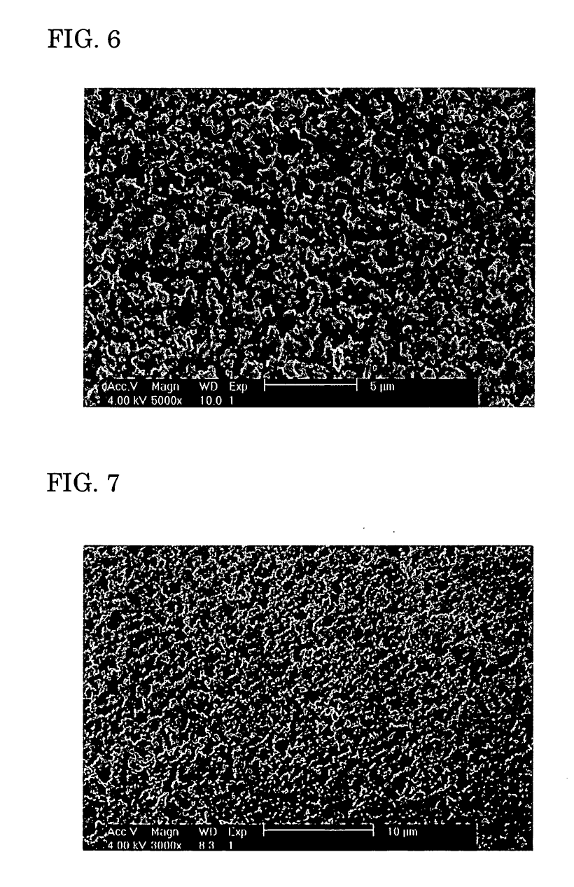

Next, an aluminum plate was coated with the surface-treating agent of Example 5 in an amount of 0.2 mg/cm² and sintered at 300° C. for one hour. An example of the scanning electron microscopic photograph of the resulting coating film is shown in FIG. 6.

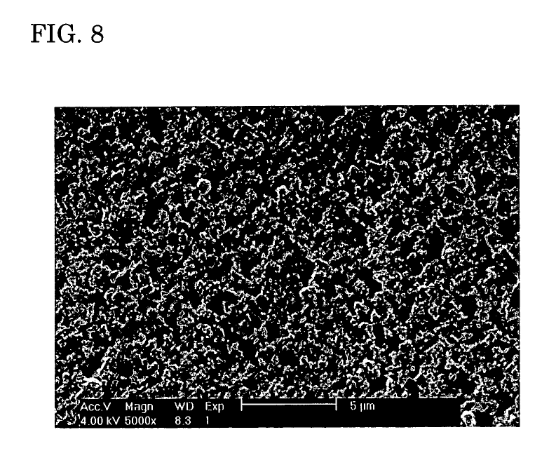

Further, a glass plate was coated with the surface-treating agent of Example 5 in an amount of 0.24 mg/cm² and sintered at 300° C. for one hour. An example of the scanning electron microscopic photograph of the resulting coating film is shown in FIG. 7. FIG. 8 is an example of the scanning electron microscopic photograph of the coating film sintered at 500° C. for one hour.

In all cases, it is obvious that a fine periodic structure with upward protrusions is formed in the coating film.

### EXAMPLE 6

100 parts by mass of the surface-treating agent of Example 1 and 2 parts by mass of anatase-type photocatalytic titanium oxide having an average particle diameter of 50 nm were admixed and further pulverized using a bead mill to prepare a surface-treated film containing titanium oxide, in the same manner as in Example 2. This coating film formed fine roughness. Further, 100 parts by mass of the surface-treating agent of Comparative Example 1 and 2 parts by mass of the abovementioned anatase-type photocatalytic titanium oxide were admixed and further pulverized using a bead mill to prepare a surface-treated film containing titanium oxide, in the same manner as in Comparative Example 2.

This coating film formed no roughness structure.

Each of the films containing titanium oxide was individually brought into contact with an aqueous monochloroacetic acid solution and then radiated with UV light at a wavelength less than 387 nm. As a result, the initial velocity in disintegrating monochloroacetic acid was improved 1.25 times faster for the film with the surface-treating agent of Example 1 than for the film with the surface-treating agent of Comparative Example 1.

### INDUSTRIAL APPLICABILITY

As mentioned above, the present invention has industrial applicability, that is, it provides a surface-treating agent characterized in that the average primary particle diameter is in the range of 1-50 nm, that it contains fine particles in the range of 5-60% by mass of the total amount of the surface-treating agent in a slurry of nanoparticles which are treated for water repellency and mechanically dispersed in a solvent containing a volatile solvent, and occasionally a water-repellent resin component in the range of 0.1-5% by mass of the total amount of the surface-treating agent, and that it forms a roughness structure with upward protrusions having a spatial periodicity of 0.1-50 μm on the surface of a material by volatilizing the solvent or dipping repeatedly in water upon treating the surface of the material, materials treated with this surface-treating agent, and an effective method of the treatment.

1. A surface-treating agent characterized in that the average primary particle diameter is in the range of 1-50 nm, that it contains fine particles in the range of 5-60% by mass of the total amount of the surface-treating agent in a slurry of nanoparticles which are treated for water repellency and mechanically dispersed in a solvent containing a volatile solvent, and that it forms a roughness structure with upward protrusions having a spatial periodicity of 0.1-50 μm on a surface of a material by volatilizing the solvent and optionally dipping repeatedly in water upon treating the surface of the material.

2. The surface-treating agent according to claim 1, wherein the slurry further comprises a water-repellent resin component in the range of 0.1-5% by mass of the mass of the surface-treating agent.

3. The surface-treating agent according to claim 1, further comprising polymeric resins including monomers and oligomers in addition to the nanoparticle slurry treated for water repellency.

4. The surface-treating agent according to claim 1, characterized in that the treatment for water repellency is selected from alkyl silane treatment, alkyl titanate treatment, and alkyl aluminate treatment.

5. A material which is obtained by further sintering a material coated with the surface-treating agent of claim 3 and has a roughness structure with upward protrusions having a spatial periodicity of 0.1-50 μm on the surface.

6. A highly water-repellent material which is obtained by further treating the material of claim 5 for water repellency and has a roughness structure with upward protrusions having a spatial periodicity of 0.1-50 μm on the surface.

7. The surface-treating agent according to claim 1, characterized in that the admixing amount of a liquid component having a dynamic viscosity of greater than 1×10⁻³ m²/s at 25° C. is less than 10% by mass of the mass of the surface-treating agent.

8. The surface-treating agent according to claim 1, characterized in that the admixing amount of a liquid component having a dynamic viscosity of greater than 1×10⁻³ m²/s at 25° C. is less than 3% by mass of the mass of surface-treating agent.

9. The surface-treating agent according to claim 1, characterized in that the treatment for water repellency is octylsilane treatment.

10. The surface-treating agent according to claim 1, characterized in that the nanoparticles are one or more selected from titanium oxide, lower titanium oxide, zinc oxide, zirconium oxide, aluminum oxide, carbon black, silicic acid anhydride, cerium oxide, gold, silver, platinum, palladium, rodium, lanthanum, vanadium, tungsten, iron oxide, iron hydroxide and cobalt oxide.

11. The surface-treating agent according to claim 1, which forms a roughness surface exhibiting an efficient photocatalytic effect by admixing a photocatalyst in less than 5% of the mass of the surface-treating agent that is a concentration not to interfere with the roughness formation.

12. The surface-treating agent according to claim 1, characterized in that a wet medium type pulverizer is used as a method of mechanically dispersing nanoparticles treated for water repellency.

13. The surface-treating agent according to claim 1, characterized in that it comprises one or more volatile solvents having a boiling point in the range of 40-99° C. at one atm.

14. The surface-treating agent according to claim 1, characterized in that the boiling point of a volatile solvent used upon preparing a slurry of nanoparticles treated for water repellency is in the range of 100-260° C. at one atm.

15. The surface-treating agent according to claim 1, characterized in that the volatile solvent used upon preparing a slurry of nanoparticles treated for water repellency is one or more selected from decamethylcyclopentasiloxane, methyl trimethicone, and tetrakistrimethylsiloxy silane.

16. The material according to claim 5, characterized in that it is a raw material selected from glass, silicon wafer, fiber, synthetic resins, and optical fiber, or a structure comprising said raw material.

17. A method of surface treatment characterized in that a material coated with the surface-treating agent of claim 1 is dried and then further soaked in water, thereby further developing roughness on the surface.

18. A surface-treating agent comprising:
water repellent nanoparticles having an average primary particle diameter of 1-50 nm, which accounts for 5-60% by mass of the agent; and
a solvent providing a slurry in which the nanoparticles are mechanically dispersed, said solvent containing a volatile solvent accounting for 2-60% by mass of the agent,
wherein the surface-treating agent is configured to self-form a roughness structure with upward protrusions having a spatial periodicity of 0.1-50 μm on a surface of a material when being applied to the surface and dried.

19. The surface-treating agent according to claim 18, wherein the slurry further comprises a water-repellent resin component which accounts for 0.1-5% by mass of the agent.
